(19) United States
(12) Patent Application Publication
(10) Pub. No.: US 2006/0012934 A1
(43) Pub. Date: Jan. 19, 2006

(54) Continuous laminate fuse

(76) Inventors: Mark A. Faulkner, Greenwood, SC (US); Arthur J. Jur, Greenwood, SC (US); Shannon C. Bradberry, Bradley, SC (US); Douglas M. Brandt, Greenwood, SC (US)

Correspondence Address: Martin J. Moran, Esquire;Eaton Electrical, Inc.,Technology & Quality Center, RIDC Park West, 170 Industry Drive, Pittsburgh, PA, 15275-1032, US

(21) Appl. No.: 10/890,426

(22) Filed: Jul. 13, 2004

(51) Int. Cl. H02H 5/04

(52) U.S. Cl. 361/104

(57) ABSTRACT

A fuse is adapted for electrical connection between a first low voltage power bus and a second low voltage power bus. The fuse includes one or more pairs of first and second spacer laminations. The first and second spacer laminations have a first area. The fuse also includes a plurality of fuse element laminations, each of which includes a first portion laminated to the first spacer lamination of one or two of the pairs, a second portion laminated to the second spacer lamination of the one or two of the pairs, and a third portion disposed between the first and second portions and intermediate the first and second spacer laminations of the one or two of the pairs. The first and second portions of the fuse element laminations have a second area, which is about equal to the first area.

### BACKGROUND OF THE INVENTION

1. Field of the Invention

The present invention relates to power circuit interruption and, more particularly, to fuses providing circuit interruption for low voltage power busses.

2. Background Information

Load side fuses of various designs are used in network protectors for underground power distribution. The primary purpose of these fuses is to act as a back-up to the network protector in the event of a malfunction thereof. Such a fuse coordinates with the network protector and should not blow on a network feeder fault before the network protector trips. However, if the network protector does not timely trip open, then the fuse must blow in a reasonable time in order to prevent transformer damage.

Copper Z, copper Y and S fuse links are designed to handle relatively high currents (e.g., about 800 A to about 6 kA) and low voltage (e.g., up to about 600 VAC_{RMS}). Typically, the fuses are made of pure copper and are silver plated. The interrupting mechanism for the fuses (e.g., copper Z; copper Y; type S) is the heat generated by passing fault level currents through a relatively small cross-sectional area of the fuse.

Known interrupting fuses that provide close to optimum melting curves, in order to permit selective operation with cable limiters, include copper link style fuses (e.g., type Y25; type Z50). However, such fuses produce about 50% of the power (watts) thermal losses inside a network protector enclosure.

Other known alloy fuses have adequate interrupting capacity and relatively more favorable power (watts) thermal loss characteristics. However, such fuses have undesirable damage and blowing characteristics and do not permit selective operation with limiters.

Another known fuse, the type “S” fuse, provides advantages in protection and blowing characteristics over alloy fuses and advantages in power (watts) thermal losses over copper link style fuses. However, the construction of type “S” fuses requires that each fuse element be brazed and pinned to a copper fuse base.

The temperature required to braze the fuse assembly weakens the relatively thin fuse elements, thereby causing variability in both damage and blowing characteristics.

There is room for improvement in fuses.

### SUMMARY OF THE INVENTION

These needs and others are met by the present invention, which provides a continuous laminate fuse to address protection and blowing characteristics, power (watts) thermal losses, and variability in damage and blowing characteristics.

Preferably, the continuous laminate fuse is not soldered and employs uniform length laminates, as contrasted with a relatively small soldered link, in order to provide advantages in power (watts) thermal losses.

The fuse may be manufactured by employing a press welding technique. With press welding, the fuse resistance value is equal to that of a flat copper bar. As a result, voltage losses are minimized, thereby maintaining a uniform current flow. Furthermore, a consistent pocket is preferably provided for tin alloy to reside.

As an aspect of the invention, a fuse is adapted for electrical connection between a first low voltage power bus and a second low voltage power bus, the fuse comprises: at least one pair of spacer laminations, each of the at least one pair including a first spacer lamination and a second spacer lamination, the first and second spacer laminations having a first area; and a plurality of fuse element laminations, each of the fuse element laminations including a first portion laminated to the first spacer lamination of at least one of the at least one pair, a second portion laminated to the second spacer lamination of the at least one of the at least one pair, and a third portion disposed between the first and second portions and intermediate the first and second spacer laminations of the at least one of the at least one pair, wherein the first and second portions of the fuse element laminations have a second area, which is about equal to the first area.

The third portion may include a fuse element alloy pocket. The fuse element alloy pocket may have a semi-rectangular profile. The semi-rectangular profile may be filled with a tin alloy in a non-interrupted state of the fuse.

The third portion may have a general V-shape.

A first count of the at least one pair of spacer laminations may be equal to a positive integer, N, and a second count of the plurality of fuse element laminations may be equal to N plus one.

A first count of the at least one pair of spacer laminations may be equal to three, and a second count of the plurality of fuse element laminations may be equal to four.

A first count of the at least one pair of spacer laminations may be equal to two, and a second count of the plurality of fuse element laminations may be equal to three.

A first count of the at least one pair of spacer laminations may be equal to one, and a second count of the plurality of fuse element laminations may be equal to two.

### BRIEF DESCRIPTION OF THE DRAWINGS

A full understanding of the invention can be gained from the following description of the preferred embodiments when read in conjunction with the accompanying drawings in which:

FIG. 1 is an isometric view of a low loss continuous laminate fuse in accordance with the present invention.

FIG. 2 is an exploded isometric view of the low loss continuous laminate fuse of FIG. 1.

FIG. 3 is vertical side elevation view of the low loss continuous laminate fuse of FIG. 1.

FIG. 4 is vertical elevation view of the low loss continuous laminate fuse of FIG. 1.

FIG. 5 is an isometric view of a low loss continuous laminate fuse in accordance with another embodiment of the invention.

FIG. 6 is vertical elevation view of the low loss continuous laminate fuse of FIG. 5.

FIG. 7 is an exploded isometric view of a low loss continuous laminate fuse in accordance with another embodiment of the invention.

FIG. 8 is an exploded isometric view of a low loss continuous laminate fuse in accordance with another embodiment of the invention.

### DESCRIPTION OF THE PREFERRED EMBODIMENTS

As employed herein, the statement that two or more parts are “connected” or “coupled” together shall mean that the parts are joined together either directly or joined through one or more intermediate parts. Further, as employed herein, the statement that two or more parts are “attached” shall mean that the parts are joined together directly.

As employed herein, the term “fastener” shall expressly include, but not be limited to, any suitable fastening member(s) (e.g., without limitation, a threaded fastener; a non-threaded fastener; a removable fastener; a non-removable fastener; a bolt; a machine screw; a rivet; a soldered connection; an adhesive connection), which is employed such that two or more parts are connected or coupled together.

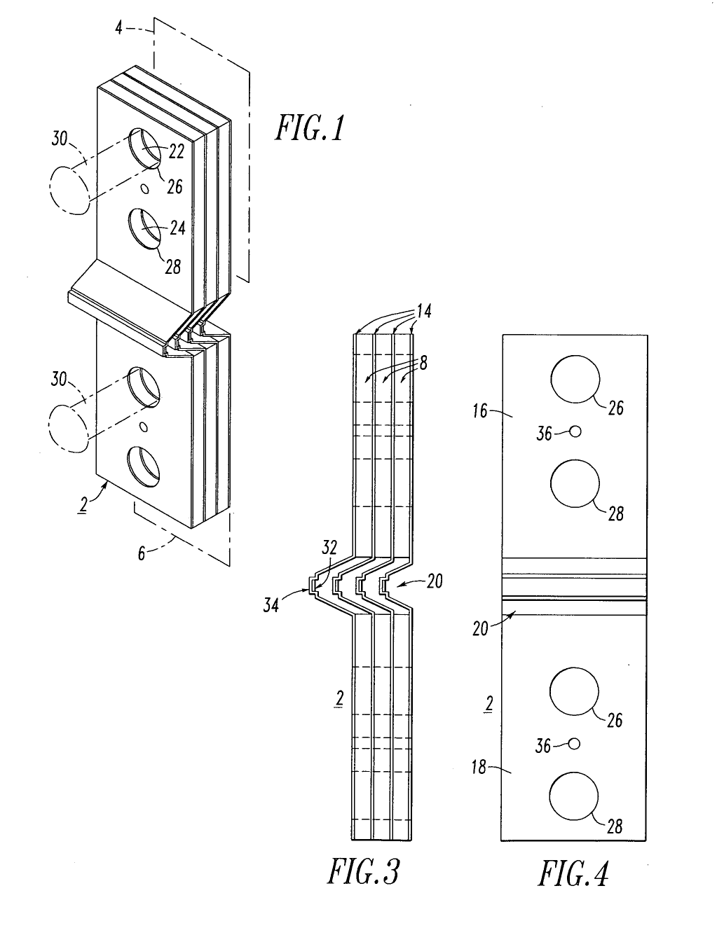

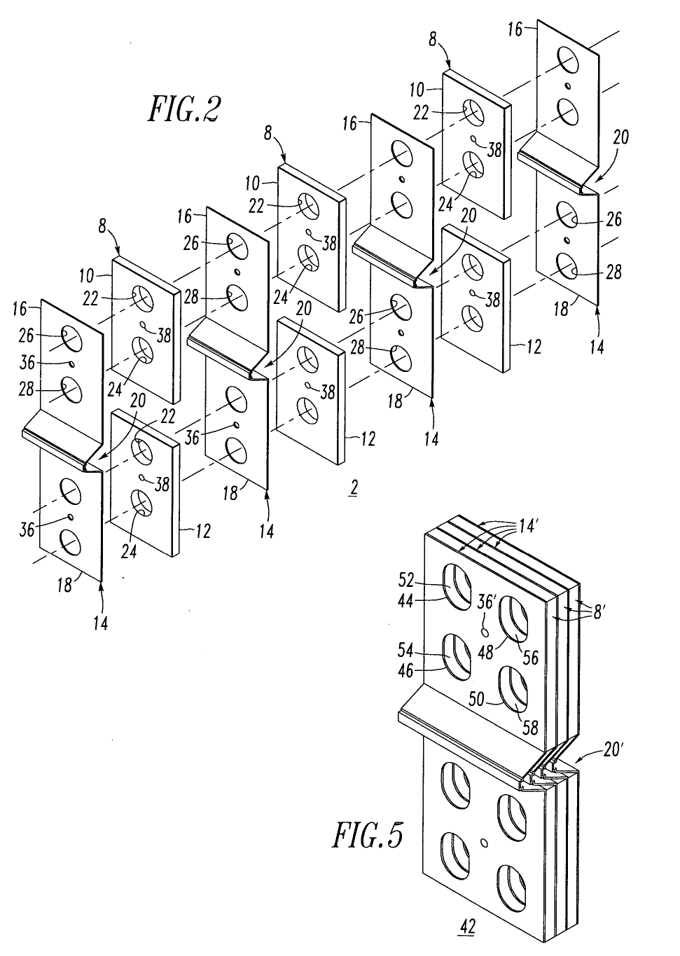

Referring to FIGS. 1-4, a low loss continuous laminate fuse 2 is shown. The fuse 2 is adapted for direct electrical and mechanical connection between a first low voltage power bus 4 (shown in phantom line drawing in FIG. 1) and a second low voltage power bus 6 (shown in phantom line drawing). The fuse 2 has a non-interrupted state (as shown in FIGS. 2-4) and an interrupted state (not shown).

The fuse 2 further includes one or more pairs 8 of spacer laminations. Each of these pairs 8 (e.g., three pairs 8 are shown in FIG. 2) includes a first spacer lamination 10 and a second spacer lamination 12. The spacer laminations 10,12 have a first area (defined by a length and a width) and are preferably made of copper having a suitable thickness. The fuse 2 also includes a plurality of fuse element laminations 14, each of which includes a first portion 16 laminated to one side of the first spacer lamination 10 of a corresponding one of the pairs 8, a second portion 18 laminated to one side of the second spacer lamination 12 of the corresponding one of the pairs 8, and a third portion 20 disposed between the first and second portions 16,18 and intermediate the first and second spacer laminations 10,12 of the corresponding one of the pairs 8. The fuse element laminations 14 are preferably made of copper. As best shown in FIG. 2, the first and second portions 16,18 of the fuse element laminations 14 have a second area (defined by a length and a width), which is about equal to the first area of the spacer laminations 10,12. In this example, the first and second portions 16,18 have a first length and a first width, the first and second spacer laminations 10,12 have a second length, which is equal to the first length, and such first and second spacer laminations have a second width, which is equal to the first width.

As best shown in FIG. 2, each of the first and second spacer laminations 10,12 includes two openings 22,24. Also, each of the first and second portions 16,18 of the fuse element laminations 14 includes two openings 26,28 corresponding to the two respective openings 22,24 of the first and second spacer laminations 10,12. The openings 22,24,26,28 are adapted to receive fasteners 30 (two of which are shown in phantom line drawing in FIG. 1) for the first and second low voltage power busses 4,6 of FIG. 1.

The fuse element laminations 14 extend and are preferably laminated between the pairs 8 of spacer laminations 10,12 by a suitable press welding method to form a fuse base. The fuse element laminations 14 are designed with a suitably consistently dimensioned pocket 32, which holds a suitable predetermined amount of an alloy 34. The alloy 34 (e.g., tin; lead; and/or a combination thereof) is applied by a cast in place method to each of the pockets 32. The alloy 34 (e.g., tin) functions (e.g., by molten metal corrosion) to start the initial melting of the fuse 2, since the alloy 34 has a lower melting temperature than that of the lamination 14 (e.g., which is made of copper). The alloy 34 amalgamates into the structure of the lamination 14 changing the resistance of the joint to a relatively high resistance and allowing for consistent interruption.

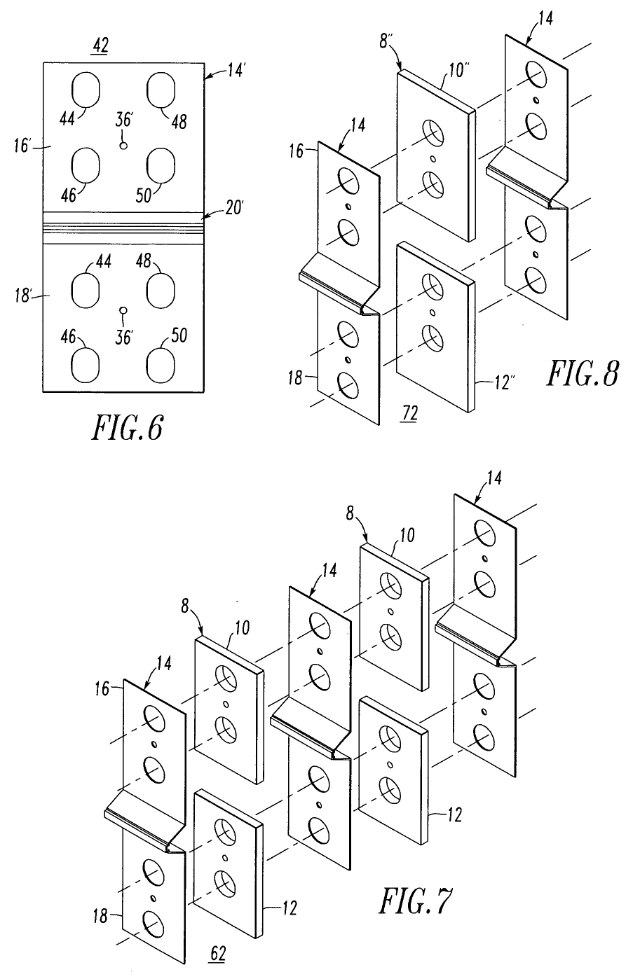

The mounting holes 22,24 through the fuse element laminations 14 are added in varying configurations (e.g., as shown in FIGS. 4 and 6) to match the fastener (e.g., bolt) patterns of corresponding network protectors (not shown). The size and count of the laminations 14 depend upon the amount of rated current for the corresponding network protector. As shown in FIGS. 1-4, a first count (e.g., a positive integer, N) of the pairs 8 of spacer laminations 10,12 is equal to three, and a second count (e.g., N plus one) of the fuse element laminations 14 is equal to four. Although example configurations are shown, a wide variety of different assemblies are possible.

As best shown in FIG. 3, the third portion 20, which has a general V-shape, of the fuse element laminations 14 includes the fuse element alloy pocket 32, which has a semi-rectangular profile. This semi-rectangular profile is filled with the tin alloy 34 in the non-interrupted state of the fuse 2.

Referring to FIGS. 2 and 4, each of the first and second spacer laminations 10,12 includes the two openings 22,24 and a relatively smaller opening 38. Also, each of the first and second portions 16,18 of the fuse element laminations 14 includes the two openings 26,28 and a relatively smaller opening 36. The smaller openings 36,38 cooperate to align the first and second portions 16,18 of the fuse element laminations 14 with the first and second spacer laminations 10,12. For example, two pins (not shown), may be employed within the two pairs of openings formed by 36,38, in order to align the pairs 8 of spacer laminations 10,12 and the fuse element laminations 14 before a press welding method is employed to form the fuse base. Although the openings 36,38 are shown, those are not required and any suitable alignment mechanism or technique may be employed.

Although fasteners 30 are disclosed, the two ends of the fuse 2 may be electrically and mechanically connected to corresponding heat sinks (not shown), which, in turn, are electrically and mechanically connected to corresponding low voltage power busses (e.g., busses 4,6). An example of such conductive heat sinks is disclosed in U.S. Pat. No. 6,510,047, which is incorporated by reference herein. Corresponding fasteners (not shown) may protrude from the terminal end (not shown) of the corresponding heat sinks. Otherwise, the fuse 2 may be directly electrically and mechanically connected to the corresponding low voltage power busses 4,6, as shown in FIG. 1.

The fuse 2 melts and vaporizes between the non-interrupted state (FIGS. 1-4) and an interrupted state (not shown), in which the third portions 20 of the fuse element laminations 14 are vaporized.

FIGS. 5 and 6 show another low loss continuous laminate fuse 42, which includes four fuse element laminations 14′ and three spacer laminations 8′. As shown in FIG. 6, each of the four fuse element laminations 14′ includes a first portion 16′, a second portion 18′ and a third portion 20′. This fuse 42 is generally similar to the fuse 2 of FIG. 1, except that the fuse 42 is relatively wider for low voltage power busses (not shown), which are relatively wider than the busses 4,6 of FIG. 1. Here, each of the first and second portions 16′, 18′ of the fuse element laminations 14′ includes four openings 44,46,48,50 corresponding to the four openings 52,54,56,58 of the spacer laminations 8′. Also, the four openings 44,46,48,50 and the corresponding openings 52,54,56,58 are adapted to receive fasteners (not shown) for the power busses (not shown). Similar to the openings 36,38 of FIG. 1, an alignment opening 36′ is provided, as shown with the first and second portions 16′,18′ of the fuse element lamination 14′ of FIG. 6.

FIG. 7 shows another low loss continuous laminate fuse 62, which is generally similar to the fuse 2 of FIG. 1, except that a first count of the pairs 8 of spacer laminations 10,12 is equal to two, and that a second count of the plurality of fuse element laminations 14 is equal to three.

FIG. 8 shows another low loss continuous laminate fuse 72, which is generally similar to the fuse 2 of FIG. 1, except that a first count of the pair 8″ of spacer laminations 10″, 12″ is equal to one, that a second count of the plurality of fuse element laminations 14 is equal to two, and that the length and/or width of the spacer laminations 10″, 12″ may be slightly greater than the corresponding length and/or width of the first and second portions 16,18 of the fuse element laminations 14.

Although press welding is disclosed, the low loss continuous laminate fuses 2,42,62,72 may be laminated by any suitable method, such as, for example, riveting, swaging, brazing and/or soldering.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A fuse adapted for electrical connection between a first low voltage power bus and a second low voltage power bus, said fuse comprising:
at least one pair of spacer laminations, each of said at least one pair including a first spacer lamination and a second spacer lamination, said first and second spacer laminations having a first area; and
a plurality of fuse element laminations, each of said fuse element laminations including a first portion laminated to the first spacer lamination of at least one of said at least one pair, a second portion laminated to the second spacer lamination of said at least one of said at least one pair, and a third portion disposed between said first and second portions and intermediate said first and second spacer laminations of said at least one of said at least one pair, wherein the first and second portions of said fuse element laminations have a second area, which is about equal to said first area.

2. The fuse of claim 1 wherein said third portion includes a fuse element alloy pocket.

3. The fuse of claim 2 wherein said fuse element alloy pocket has a semi-rectangular profile.

4. The fuse of claim 3 wherein said fuse has an interrupted state and a non-interrupted state; and wherein said semi-rectangular profile is filled with a tin alloy in the non-interrupted state of said fuse.

5. The fuse of claim 2 wherein said third portion has a general V-shape.

6. The fuse of claim 1 wherein each of said first and second spacer laminations includes two openings; wherein each of the first and second portions of said fuse element laminations includes two openings corresponding to the two openings of said first and second spacer laminations; and wherein the two openings of said fuse element laminations and the two openings of said first and second spacer laminations are adapted to receive fasteners for said first and second low voltage power busses.

7. The fuse of claim 1 wherein each of said first and second spacer laminations includes four openings; wherein each of the first and second portions of said fuse element laminations includes four openings corresponding to the four openings of said first and second spacer laminations; and wherein the four openings of said fuse element laminations and the four openings of said first and second spacer laminations are adapted to receive fasteners for said first and second low voltage power busses.

8. The fuse of claim 1 wherein each of said first and second spacer laminations includes a plurality of first openings and a smaller second opening; wherein each of the first and second portions of said fuse element laminations includes a plurality of third openings and a smaller fourth opening; and wherein said smaller second and fourth openings cooperate to align the first and second portions of said fuse element laminations with the first and second spacer laminations.

9. The fuse of claim 1 wherein the first and second portions of said fuse element laminations have a first length; and wherein the first and second spacer laminations have a second length, which is equal to said first length.

10. The fuse of claim 1 wherein the first and second portions of said fuse element laminations have a first length; and wherein the first and second spacer laminations have a second length, which is substantially the same as the first length.

11. The fuse of claim 10 wherein the first and second portions of said fuse element laminations have a first width; and wherein the first and second spacer laminations have a second width, which is substantially the same as the first width.

12. The fuse of claim 1 wherein the first and second portions of said fuse element laminations have a first width; and wherein the first and second spacer laminations have a second width, which is equal to said first width.

13. The fuse of claim 12 wherein the first and second portions of said fuse element laminations have a first length; and wherein the first and second spacer laminations have a second length, which is equal to said first length.

14. The fuse of claim 1 wherein the first and second portions of said fuse element laminations have a first width; and wherein the first and second spacer laminations have a second width, which is substantially the same as the first width.

15. The fuse of claim 1 wherein a first count of said at least one pair of spacer laminations is equal to three; and wherein a second count of said plurality of fuse element laminations is equal to four.

16. The fuse of claim 1 wherein a first count of said at least one pair of spacer laminations is equal to two; and wherein a second count of said plurality of fuse element laminations is equal to three.

17. The fuse of claim 1 wherein a first count of said at least one pair of spacer laminations is equal to one; and wherein a second count of said plurality of fuse element laminations is equal to two.

18. The fuse of claim 1 wherein N is an integer greater than or equal to one; wherein a first count of said at least one pair of spacer laminations is equal to N; and wherein a second count of said plurality of fuse element laminations is equal to N plus one.

19. The fuse of claim 1 wherein said fuse is adapted to be directly electrically and mechanically connected to both of a first low voltage power bus and a second low voltage power bus.

20. The fuse of claim 1 wherein said spacer laminations are made of copper.

21. The fuse of claim 1 wherein said fuse element laminations are made of copper.
